(19) United States
(12) Patent Application Publication
(10) Pub. No.: US 2004/0129127 A1
(43) Pub. Date: Jul. 8, 2004

(54) Violin with enhanced components

(76) Inventor: James A. Mercer, Newport News, VA (US)

Correspondence Address: JAMES A. MERCER II, 12496 WARWICK BLVD., NEWPORT NEWS, VA, 23606, US

(21) Appl. No.: 10/642,853

(22) Filed: Aug. 18, 2003

Related U.S. Application Data
(63) Continuation-in-part of application No. 09/901,537, filed on Jul. 9, 2001, now abandoned.

(51) Int. Cl. G10D 3/04

(52) U.S. Cl. 84/307

(57) ABSTRACT

An apparatus adding one new component and replacing four outdated parts with enhanced components, which have characteristics that efficiently transfer and recycle sound vibrations, have correct wood grain direction for optimal sound flow, and are designed with “lower impendence to movement characteristics”, and if and when this apparatus is added to a violin it will resonate longer, project more sound frequencies further, produce a stronger response, and require half the bowing effort.

### CROSS REFERENCE TO RELATED APPLICATIONS

This is a continuation in part of Ser. No. 09/901,537, filed on Jul. 9, 2001.

### FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates specifically and solely to the four members of the acoustic violin family and is an apparatus to enhance and improve violin acoustic output by replacing the conventional sound post, with the acoustic post, the bridge with a Mercer bridge, the tailpiece with the harmonics device and bass bar with a Mercer Bass bar and adding the Mercer Bass bar acoustic device. The guitar is entirely different, and has no similarities to the violin. This is a non electric or acoustic instrument only and relates to the violin family which is composed of four members the violin, viola, cello, and double bass fiddle which differ mainly in size and higher or lower octave string configuration. The violin has no similarity in shape to any other musical instrument and there are no similarities in the shape of any internal violin parts, or method of playing or sound produced.

### History

The violin is thought to have evolved from two Medieval bowed instruments, the fiddle or fiedel and the rebec. The sixteenth century produced the earliest well-known violin makers: Italians Gasparo da Salo and Giovanni Maggini in Brescia, and Andrea Amati in Cremona. Further violin advancements were made in the seventeenth and eighteenth centuries by the Italians Antonio Stradivari and Giuseppe Guarneri in Cremona, and Jacob Stainer in Austria. Basically, the violin is a wooden box with a top plate and a back plate joined by ribs. Traditionally, the top plate is made of well-aged or seasoned spruce and the back plate is made of well-aged maple. Inside the violin a long strip of wood called the bass bar which is glued to the inside of the top plate under the bass side of the bridge acts as a structural reinforcement. Also a thin round piece of wood, the sound post wedged under the treble side of the bridge connects the top plate and back plate of the violin adding structural stability on the treble side of the violin. These two centrally located structural reinforcements are important because the combination of all the violin strings produces a downward force on the violin top plate totaling over 150 pounds. The scroll contains a peg box with tuning pegs. The violin strings are attached to the tuning pegs and are suspended over the neck and fingerboard, where they rest on the bridge and are fastened to and terminate at the tailpiece which is looped over the endpin for attachment.

There have been very few “well accepted” or discernable changes in the violin in over three hundred years. These changes consist of the addition of modern metal strings, the mortised style attachment of the violin neck instead of the nail on style, and the increased angle at the point of attachment of the neck, making a higher bridge possible. However, there have been many, mostly unsuccessful violin patents. The reason for their lack of success was that these violin changes were generally unknown or that musicians perceived the production cost and selling price prohibitively expensive, or they were not engineered to be effective. A patent search reveals that there were five patents regarding the sound post, six patents regarding the bridge, three patents regarding the tailpiece and twenty three patents regarding the bass bar. There are no patents regarding the added part “the Mercer bass bar acoustic device” because it is a new concept and no one has challenged it with an improved design, as of now. Violin design adequately met musicians' needs until the early nineteen hundreds when the advent of metal strings began to be popular. This improvement changed the physics involved in the violin and opened the door for future violin improvements. Had the invention described herein and the advent of metal violin strings been contemporaneous, violin musicians would have had not only better strings, but better violins as well. However, as has always been the case, some violins are better than others. The problem with current violin technology is that violins affordable to the general public are usually of limited quality, thus producing mediocre-sounding violins has become the norm. Most beginning violinists become frustrated with the limited sound afforded by their “student” violins and do not continue their violin studies. The ones who persevere in spite of their violin's acoustic limitations are so rare that they are referred to as having “the gift”. What is truly remarkable is that this newly invented violin described herein not only has a beautiful sound, but a much larger percentage of humanity will now be able to more easily play the most difficult of all musical instruments with greater ease and more rewarding sound. The statement that “life is hard, but violins are harder” is still quite accurate. However, with this invention a struggling violin student can play a wrong note and the sound of that wrong note can be a more forgivable wrong sound on a violin benefiting from these technological improvements.

### Object

The object of the invention is to replace the violin's existing sound post with the invented “Mercer Acoustic Post”, replace the existing violin bridge with the “Mercer Bridge”, replace the existing violin tailpiece with the “Mercer Harmonics Device”, and replace the existing violin bass bar with a “Mercer Bass Bar” and add an additional part the “Mercer Bass Bar Acoustic Device” resulting in a two-fold increase in dominance and distance of sound projection, and increased resonating capability and requiring half the bowing effort.

Other objects and advantages of the present invention are apparent in the following descriptions and accompanying drawings, wherein, by way of illustration and example, an embodiment of the present invention is disclosed.

### SUMMARY

Replacing the violin's sound post, bridge, tailpiece, and bass bar in accordance with the present invention's apparatus with the Mercer Acoustic Post, Mercer Bridge, Mercer Harmonics Device, Mercer Bass Bar, and add the Mercer Bass Bar Acoustic Device.

### BRIEF DESCRIPTION OF THE DRAWINGS

FIG. 1 is a perspective view of the traditional violin showing important reference points and illustrating a traditional violin and labeling what is old and known: violin strings 1, bridge 2, bridge placement area 3, f holes 4, top plate 5, string adjuster tension arm 6, string adjuster's adjusting nut 7, tailpiece 8, and endpin 9

FIG. 2 for further reference is a perspective view of the commonly used strings adjuster 10 its tension arm 6, and adjusting nut 7

FIG. 3 also for reference is perspective view of the violin's interior showing the: traditional sound post 14, bass bar 15, and endpin 9

FIG. 4 is a drawing demonstrating a perspective view of a sectional cut away illustration featuring the 6 wing Mercer acoustic post and labeling its elongated central shaft 20 and one of its six acoustic wings 21

FIG. 5 is a perspective view of the 6 wing Mercer acoustic post (which replaces the sound post 14 shown in FIG. 3) showing the acoustic wings 21 and the elongated central shaft 20; and

FIG. 6 the top view,

FIG. 7 the side view,

FIG. 8 the end view

FIG. 9 is a perspective view of an alternate design: the “footed 6 wing Mercer acoustic post” labeled feet 22, acoustic wings 21, and its elongated central shaft 20; and

FIG. 10 the top view and

FIG. 11 the end view and

FIG. 12 the side view, and

FIG. 13 the bottom view

FIG. 14 is a perspective view of the another alternate design: the four wing Mercer acoustic post showing the acoustic wings 21, and the elongated central shaft 20; and

FIG. 15 the top view and

FIG. 16 the side view

FIG. 17 is a perspective view of the alternate design a two wing Mercer acoustic post designed to be installable thru the f hole and labeling the acoustic wings 21, the elongated central shaft 20; and

FIG. 18 the top view and

FIG. 19 the side view and

FIG. 20 the end view

FIG. 21 is a perspective view of an alternate 8 wing Mercer acoustic post labeling the elongated central shaft 20, and an example of acoustic wings 21, oriented laterally and at a diagonal angle to the violin strings 1, and other acoustic wings 21, which are oriented parallel to the violin strings 1; and

FIG. 22 the end view and

FIG. 23 the top view, and

FIG. 24 the side view

FIG. 25 is a perspective view of the Mercer shared bridge, illustrating the grain of the wood oriented perpendicular 34 to the direction of the violin strings 1, the contoured bottom surface conforming to the external bridge placement area 31, and the uninterrupted solid mass structure of the bridge 32

FIG. 26 shows the top view of the Mercer shared bridge, showing the slightly fluted bass 35 next is

FIG. 27 the side view showing the contoured bottom surface 31, the slightly fluted shape of the base 35 next is

FIG. 28 the front view showing the grain of its wood to be oriented perpendicular to the direction of the strings 34, the uninterrupted solid mass structure 32, and the contoured bottom surface 31

FIG. 29 is a perspective view of the Mercer Tri Bridge 30, showing the grain of its wood oriented perpendicular to the direction of the violin strings 34, and the fitted contoured bottom of the bridge 31, and the bass notch 39, tenor notch, 38, and treble notch 37, also referred to as isolation notches, the entirely solid uninterrupted mass structure of the bridge 32; and

FIG. 30 the top view showing the slightly fluted base 35, the base notch 39,the tenor notch 38, the treble notch 37, and

FIG. 31: the front view, and

FIG. 32 the side view

FIG. 33 is a perspective view demonstrating a Mercer uno harmonics device and pertinent labeled parts are: the receiving member platform 40, the heavy musical string 41, the violin strings 1, the string adjuster arm 6 and adjusting nut 7

FIG. 34 is a perspective view of a Mercer uno harmonics device, showing the harmonics device receiving member platform, 40 the string adjusting nut, 7, the string adjuster arms 6 and heavy wire or heavy musical string 41, and

FIG. 35 the side view, and

FIG. 36 the end view

FIG. 37 is a perspective view of an alternate style Mercer uno harmonics device, showing the string adjuster arms 6, string adjusting nut 7, the receiving member platform 40, the jewel placement area 45 and heavy wire or heavy musical string 41 and

FIG. 38 the side view, and

FIG. 39 the plan view

FIG. 40 is a drawing showing the perspective view demonstrating a Mercer dual harmonics device installed on a violin with the two separate receiving member platforms 42, heavy wire or heavy musical string 41 the strings adjuster arms 6, the string adjusting nut 7, and violin strings 1

FIG. 41 is a perspective view of a Mercer dual harmonics device labeling the dual string attachment receiving member platforms 42, the string adjuster arm 6 the string adjuster nut 7, and the heavy wire or heavy musical string 41, that loops over the endpin 9, for attachment; and

FIG. 42 the side view,

FIG. 43 the end view

FIG. 44 is a detached two part drawing demonstrating a perspective view of a Mercer quad harmonics device with four separate receiving member platforms positioned on a view of a violin, labeling its quad receiving member platforms 44, the violin strings 1, the heavy wire or heavy musical string 41 and the mechanical tuning head 49

FIG. 45 is a perspective view of a Mercer quad harmonics device labeling its quad receiving member platforms 44, the round drilled receptacle point of attachment 46, the violin strings 1, and the heavy wires or heavy musical strings 41 and

FIG. 46 the top view of one of the quad receiving member platform 44,

FIG. 47 the perspective view of a quad receiving member platform,

FIG. 48 the side view of a quad receiving member platform 44

FIG. 49 is a drawing demonstrating a perspective view of a flat and simple Mercer style bass bar 5 properly positioned in a sectional cut away of a violin

FIG. 50 is a perspective view of the Mercer I Bass bar 61 defined as a interior structural support member having the grain of the wood oriented perpendicular to the direction of the strings 34; instead of parallel to the direction of the violin strings as is traditional violin bass bars, and with

FIG. 51 the top view,

FIG. 52 the side view, and

FIG. 53 the end view

FIG. 54 is a perspective view of the Mercer II bass bar 62, which is identical to the Mercer I Bass Bar 61 except its attachment surface contains a series of arches or notches called amphidome arches or notches 50, and also a series of what is called the amphidome feet 51,

FIG. 55 the top view,

FIG. 56, the side view,

FIG. 57 the end view

FIG. 58 is a perspective view of a Mercer III bass bar 63, which is a three part laminate with the thicker central part labeled 52 and the central part of the laminate having the grain of the wood oriented perpendicular in direction to the violin strings 34 and its center portion 52 is plated on its outer edges 53 to strengthen the bar with its grain direction oriented parallel to the strings 55; and

FIG. 59 top view,

FIG. 60 the side view, and

FIG. 61 the end view.

FIG. 62 is a perspective view of a Mercer IV bass bar 64, which is also a three part laminate with the thicker central part of the laminate labeled 52 with central portion grain of wood orientation perpendicular to the direction of the violin strings 34, and the center portion 52, is plated on the outer edges 53 to strengthen the bar with its grain oriented parallel to the direction of the strings 55; and a series of arches or notches called amphidome arches or notches 50, and the foot of the series called the amphidome feet, 51; and

FIG. 63 the top view,

FIG. 64 the side view, and

FIG. 65 the end view

FIG. 66 is a perspective view of a Mercer V bass bar 65, with the grain of the woo oriented parallel to the direction of the strings 55, a series of amphidome arches or notches 50, and a series of amphidome feet 51; and

FIG. 67 the top view,

FIG. 68 the side view,

FIG. 69 the end view

FIG. 70 is a demonstrative drawing demonstrating the single Mercer Bass bar acoustic device part that is added to the apparatus with the other enhanced components, and is a perspective view of the device positioned in a sectional cut away of a violin labeling the outer perimeter acoustic area 76, the acoustic rudder area 71, the vibrato area 77 and also showing a six winged acoustic post

FIG. 71 is a perspective view of the single Mercer bass bar acoustic device with the vibrato area 77, the outer perimeter acoustic area 76, the acoustic rudder area 71, and the grain of the wood oriented perpendicular to the direction of the violin strings 34 and

FIG. 72 side view,

FIG. 73 the top view,

FIG. 74 the end view

FIG. 75 is a perspective view of an example of two or more bass bar acoustic devices added to a single violin picturing a two part or “Mercer double bass bar acoustic device” and labeling the vibrato area 77, the outer perimeter acoustic area 76, the acoustic rudder area 71, the grain of the wood oriented perpendicular to the direction of the strings 34 and

FIG. 76 the top view, and

FIG. 77 the end view

FIG. 78 is a side view of an alternate bass bar acoustic device called “the Mercer single long bass bar acoustic device”, with the vibrato area 77, the outer perimeter acoustic area 76, the acoustic rudder area 71, and the grain of the wood oriented perpendicular to the direction of the violin strings 34 and

FIG. 79 the top view,

FIG. 80 the end view and

FIG. 81 the top view of an optional double long bass bar acoustic device to show that two or more long bass bar acoustic devices can be added to one violin

FIG. 82 is a larger perspective view of the merger of two separate violin parts formed out of a single solid piece of wood without glue joints. The first part, a Mercer II bass bar pictured in FIG. 54 is combined with the second part, the “Mercer bass bar acoustic device” pictured in FIG. 71 producing the one piece“Mercer acoustic bar”. Its labeled parts are the outer perimeter acoustic area 76, the acoustic rudder area 71, the vibrato area 77, the amphidome arches or notches 50 and the amphidome feet 51

FIG. 83 is a larger perspective view demonstrating the merger of a single Mercer II bass bar pictured in FIG. 54 and a long bass acoustic device pictured in FIG. 78 combined together and carved from one solid piece of wood eliminating glued joints and referred to as a one piece Mercer long acoustic bar Its labeled parts are the vibrato area 77, outer perimeter acoustic area 76, inner acoustic rudder area 71, the amphidome arches 50 and the amphidome arch feet 51

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DETAILED DESCRIPTION

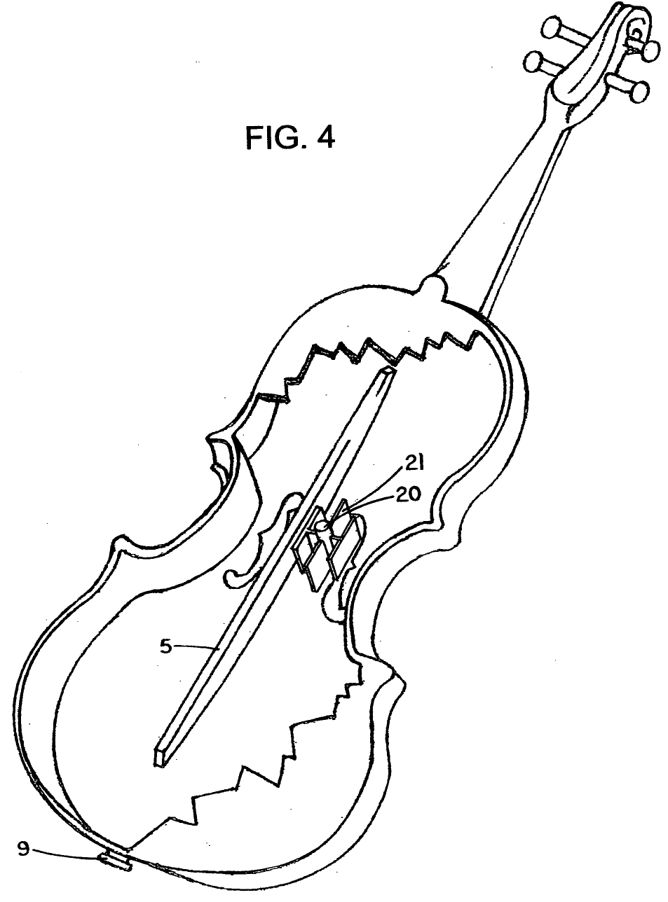

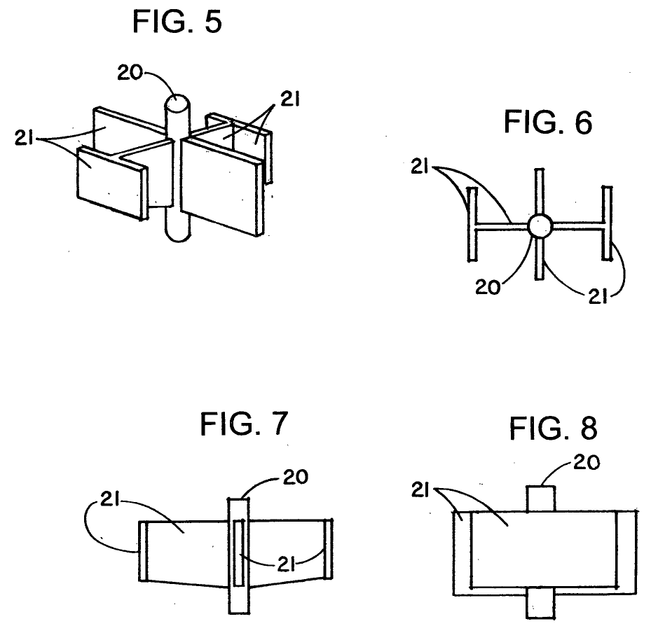

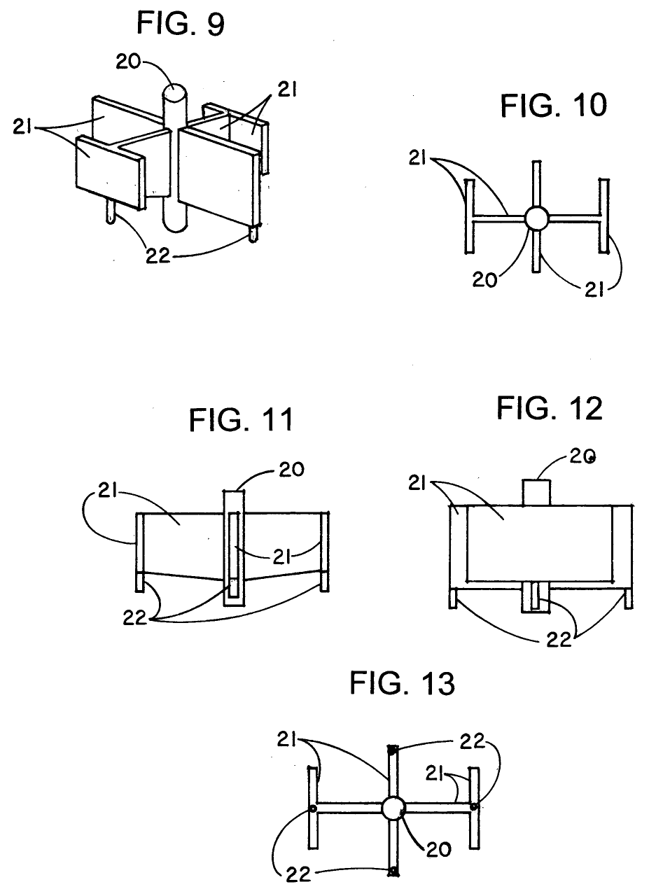

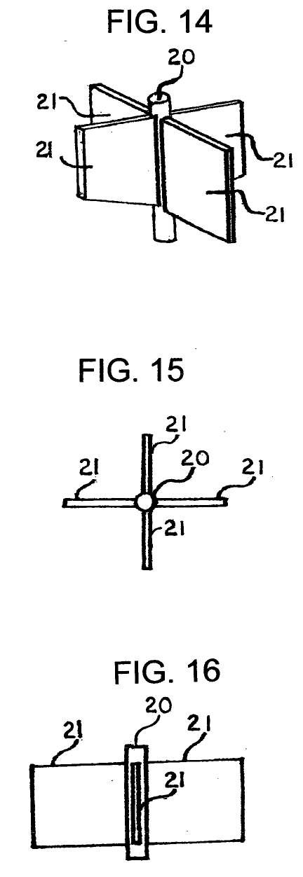

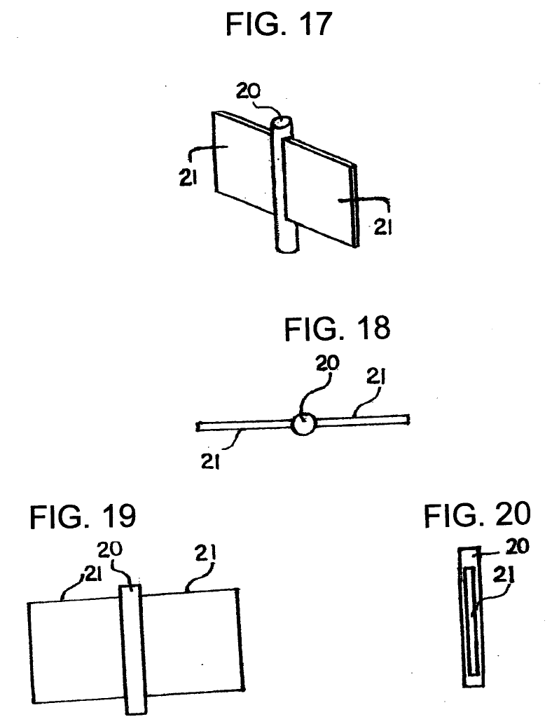

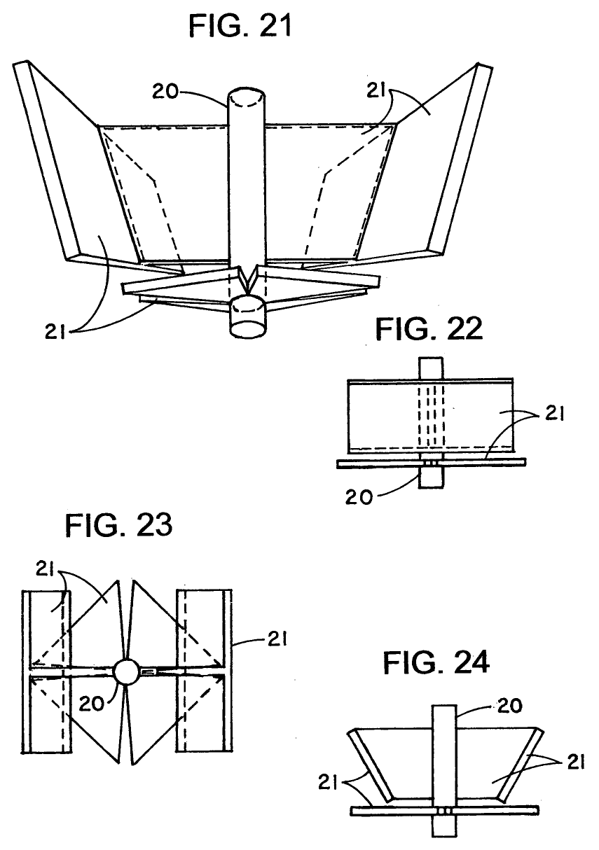

The Mercer acoustic post pictured in FIG. 5, and options pictured in FIG. 9, FIG. 14, FIG. 17 and FIG. 21, designed with the elongated center shaft having projecting rectangular blade like wings referred to as “acoustic wings” 21, which serve to absorb and retransmit sound vibrations that add to the violin sound. These Mercer acoustic posts are a totally new concept and nothing of this nature has ever been invented.

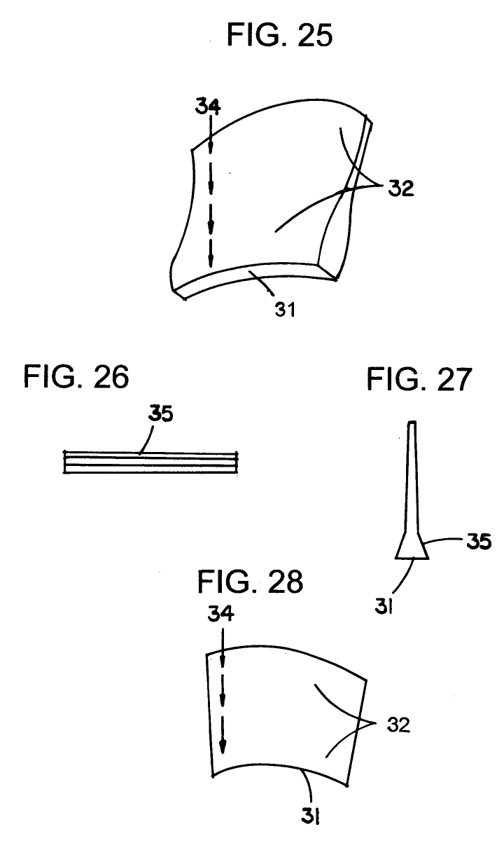

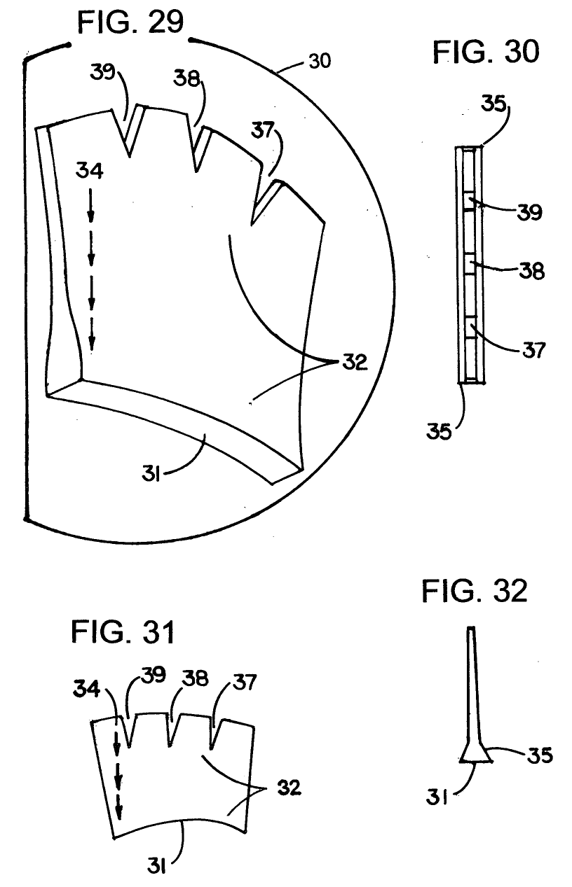

The Mercer Bridge FIG. 25 and the Mercer Tri-Notch Bridge, FIG. 29 has three main characteristics. First it is designed with a solid mass surface free of decorative filigree apertures that would interrupt sound vibrations as they pass through the bridge. Second is that the entire slightly fluted contoured bottom surface conforms with, touches, and has full contact with the violin bridge placement area on the violin top plate. Third, the grain of the wood is oriented perpendicular to the direction of the violin strings 1. The Mercer Bridge is considered a shared bridge just as the most popular traditional bridge is the shared Stradivarius Bridge, meaning when a string is bowed the other strings sharing the same bridge vibrate to a lesser degree and contribute to the sound. In this particular invention this is a problem because the other much higher frequency output strings tend to accelerate the lower frequency G string (98 hertz) with far more intensity than a regular violin giving the G a less “bass” sound that is easily corrected by adding what the inventor calls a bass notch 39. The Mercer Tri-Notch Bridge FIG. 29 is exactly the same as the Mercer Bridge FIG. 25 with the addition of three isolation notches: a bass notch 39, a tenor notch 38, and a treble notch 37. In one embodiment these isolation notches measured ⅜″ deep and 3/16″ wide at the top. Isolation notches on a shared bridge add purity to the note sound. In one embodiment the Mercer Tri-Notch Bridge measured 1 ¼″ wide across the bottom. The Mercer Bridges and Mercer Tri-Notch Bridges are installed on a violin in the same manner as any other bridge except the entire bottom surface has to be fitted instead of the conventional two small feet. Comparatively, prior technology only has two small feet transferring sound vibrations and sound vibrations are lost when they are blocked by the beautiful filigree designs. The Mercer Bridge and the Tri-Notch Bridge are newly invented and nothing of this nature has ever been invented.

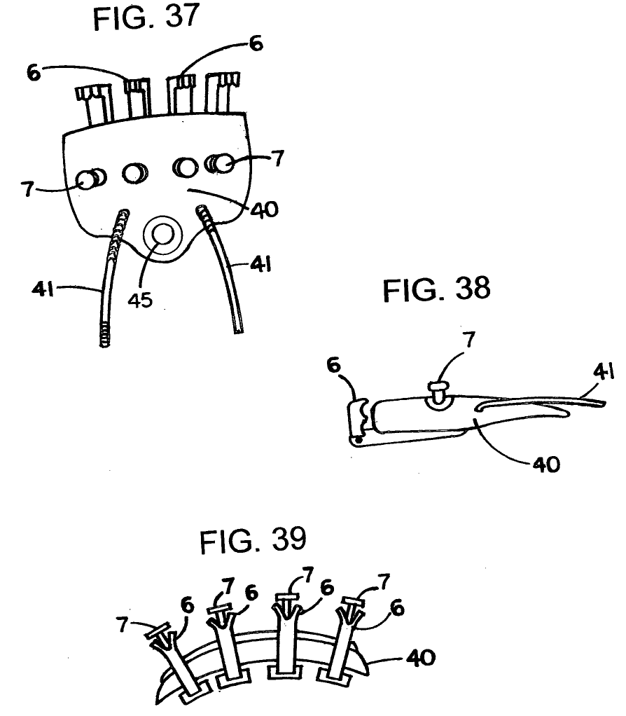

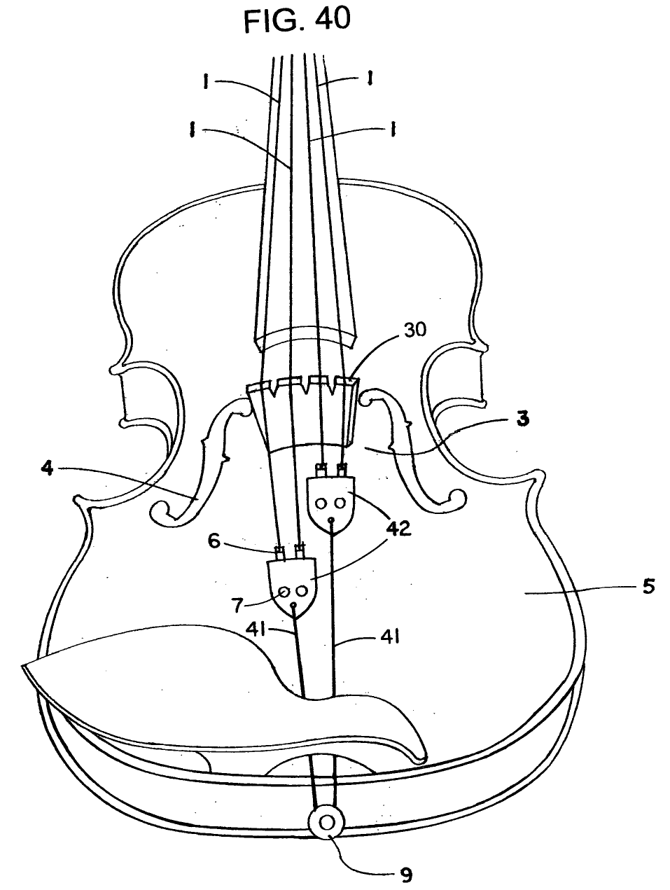

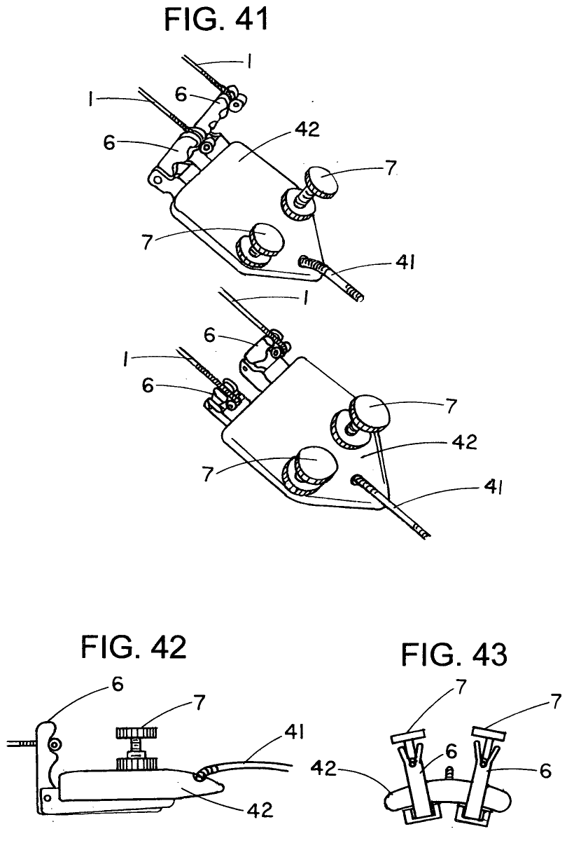

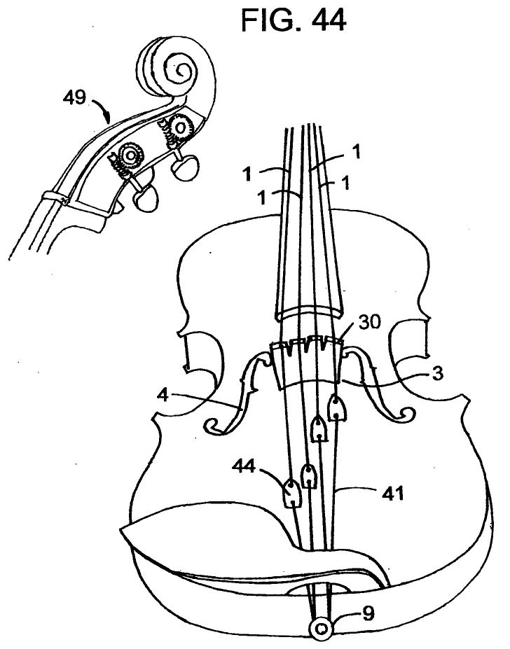

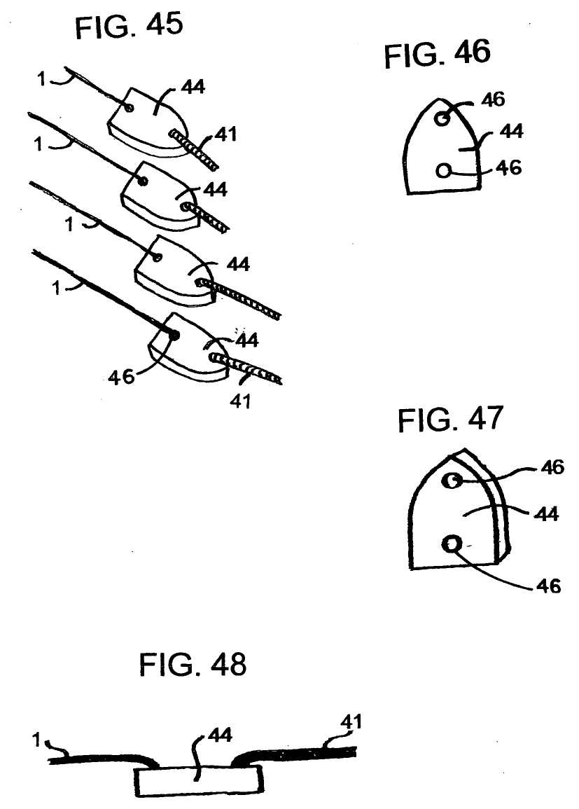

The Mercer Uno, Dual, and Quad harmonics devices are pictured in drawings in FIGS. 33 to 48 and concern the violin tailpiece replacement. The violin tailpiece is replaced by the Mercer Harmonics Device or devices and is position able as said tailpiece and are constructed of a one-piece, two-piece, or four-piece design; composed of receiving member platforms 40, 42, or 44. The string adjusters 10 are secured to round drilled receptacles at one end of the receiving members' platform 40 or 42, and the heavy musical string or wire 41, is attached to the other round drilled receptacle on the opposite end by way of an ordinary square knot tied on the underside of the receiving member platform and the size of the knot being larger than the smaller round receptacle holds it in place on the receiving member platform thus forming a loop which is looped over the endpin for means of attachment as pictured in FIG. 33, FIG. 40, and FIG. 44. Because of its light material weight which gives it a low-impedance to movement characteristic as well as the flexibility and sound-carrying characteristics of the heavy musical string the Mercer Harmonics Device enables the violin strings 9, to start vibrating with half the bowing effort and also results in a two-fold increase in dominance and distance of sound projection, and increased capability to resonate. In two separate embodiments, the first being a one piece harmonics device pictured in FIG. 33 and the second, a two piece harmonics device pictured in FIG. 40 both with string adjusters 10, and both using a 56 gauge guitar string for the wire attachment there total weight was the same amount which is 1.25 ounces and in another embodiment of a quad harmonics device pictured in FIG. 44 without string adjusters has the total weight of ¾ of an ounce. The harmonics device adds further enhancement, because the heavy musical string or wire carries the sound vibrations to the endpin which is placed in the heaviest wooden framing block of the violin, which in turn recycles the vibrations back into the violin body where they can further add to the violin sound. Comparatively, the prior art “the tailpiece” has only one purpose which is for string attachment. Options FIG. 41 and FIG. 45 add the advantage of “away from the bridge distance” to vary or be changed by lengthening or shortening the looped shaped heavy musical string.

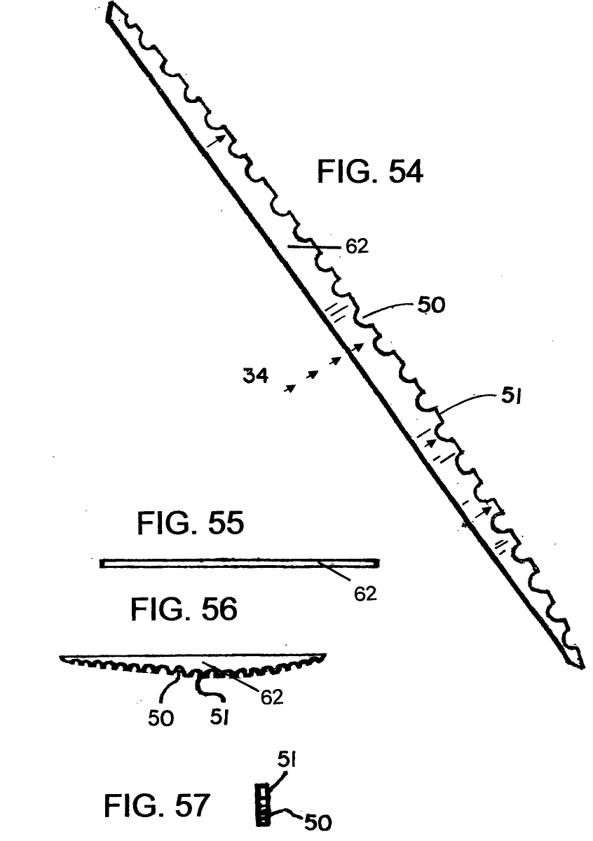

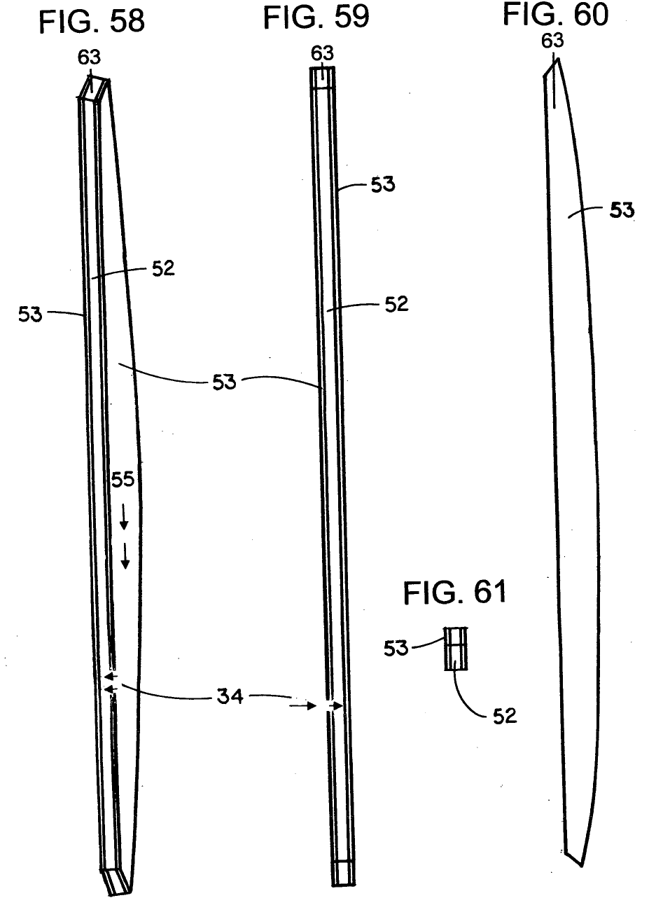

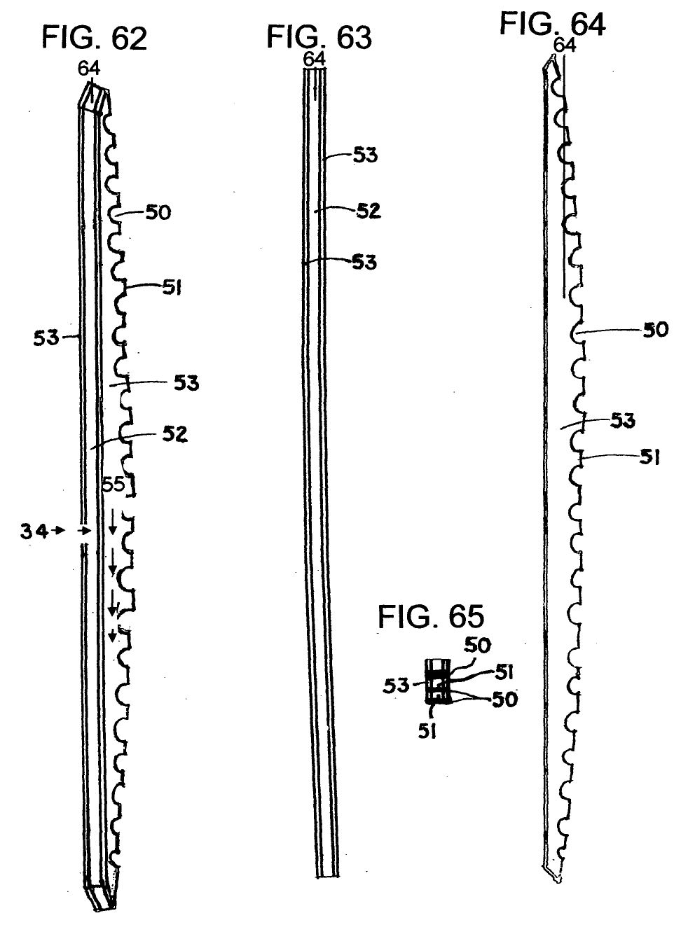

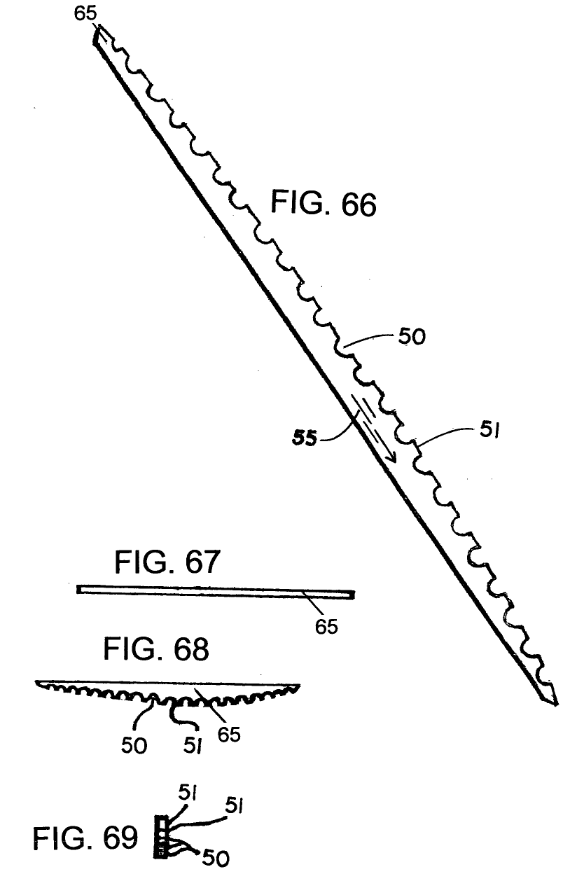

The Mercer I Bass Bar FIG. 50, and alternates FIG. 54, FIG. 58, FIG. 62 and FIG. 66 are characterized with the grain of the wood oriented perpendicular to the direction of the violin strings giving it optimal sound flow characteristics and the Mercer II Bass Bar, the Mercer IV Bass Bar and the Mercer V Bass Bar pictured in FIGS. 54, 62, and 66 has a series of added arches or notches called amphidome arches or notches 50 giving it structural support strength without stiffness in-so-far-as allowing the violin top plate new freedom of movement because of less bass bar surface contact. In one embodiment the amphidome arches or notches are cut every ½ inch on center and are 6/32″ wide and 3/32″ high reducing the surface attachment area by 45 percent. These between the amphidome feet unencumbered top plate areas are left open and free to vibrate. Comparatively the traditional bass bar is necessary for structural strength but the bar suppresses movement and limits the ability of the top plate to vibrate and produce sound vibrations. The modern violin strings, increased bridge height and increased violin neck angle has caused more downward force on the top violin plate requiring larger and stronger bars. These larger and stronger bars have made the top plate even less flexible. the Mercer II, IV, and V bass bars suppresses movement less by having less surface area to structurally support the top plate yet giving it adequate strength. There are no other bass bars designed in this manner.

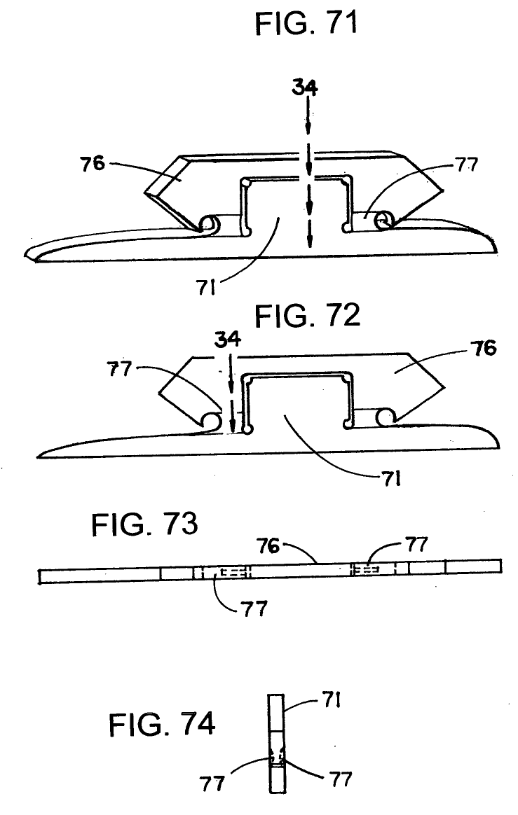

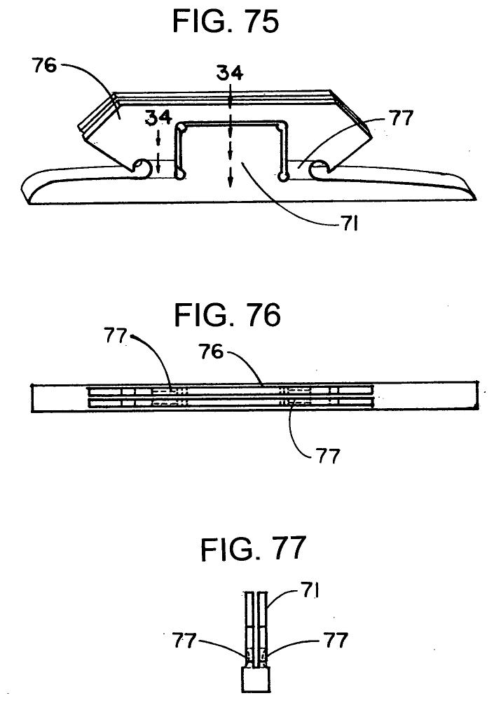

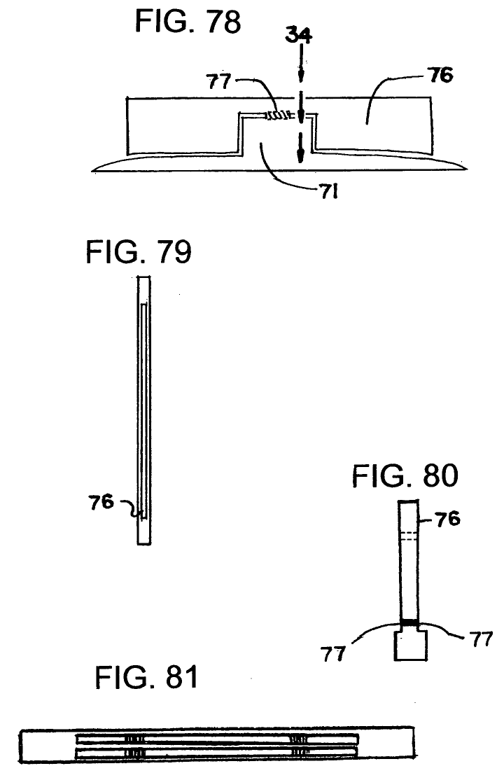

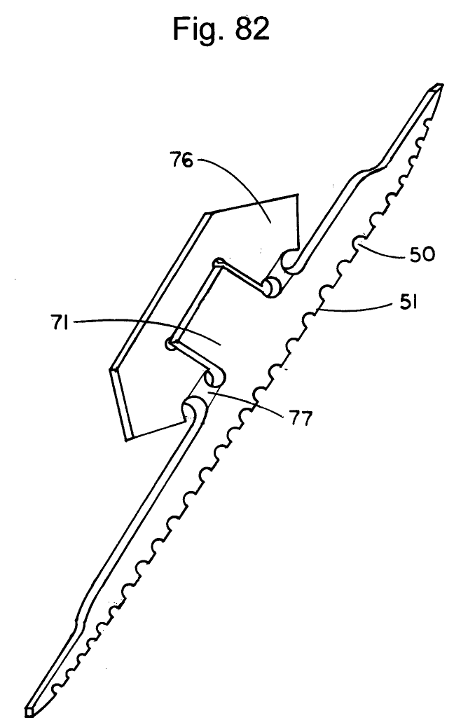

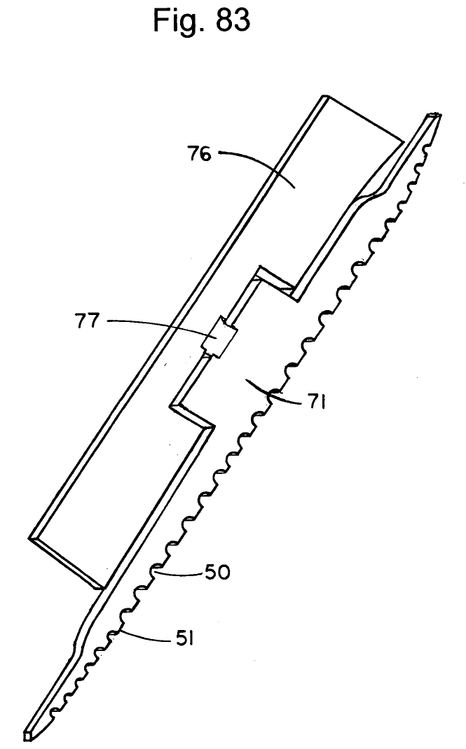

The Mercer Bass Bar acoustic device FIG. 71 and alternates FIG. 75 and FIG. 78 are devices designed with a vibrato area 77, an outer perimeter acoustic area 76, and an inner acoustic rudder area 71. The Mercer Bass Bar Acoustic Device absorbs internal sound vibrations that are carried to the bass bar and then to the top plate, thus adding these acoustic enhancements to the violin sound. In one embodiment the vibrato area 77 is made 2½ millimeters thick and the thinness of this feature allows the start off vibration a very quick starting response which acts to have a domino effect in starting the thicker central acoustic rudder device 71 into motion. In two embodiments shown in FIGS. 82 and 83 the bass bars and bass bar acoustic devices are combined together and carved from one solid piece of wood eliminating glue joints. The two formed together are called acoustic bars. There is no prior art related to this device.

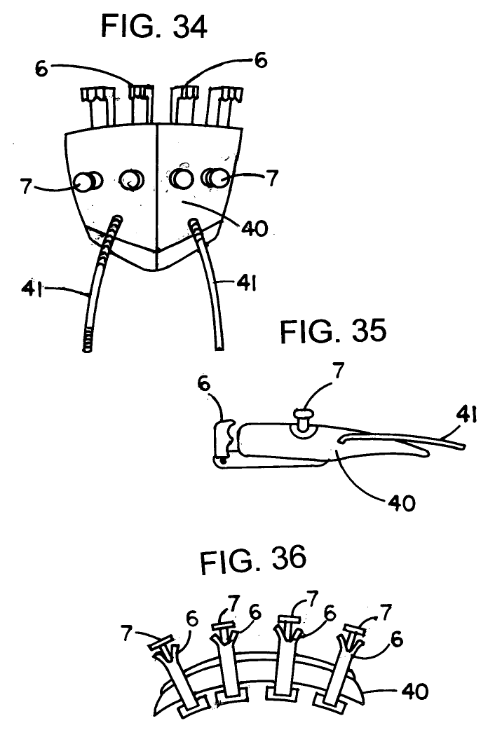

The invention is an acoustic violin family apparatus produced as a result of a much-needed reengineering of the current, outdated 300-year-old violin construction components. The invention replaces the sound post with a Mercer Acoustic Post pictured in FIG. 5, FIG. 9, FIG. 14, FIG. 17, or FIG. 21, the bridge with a Mercer Bridge pictured in FIG. 25, or FIG. 29, the tailpiece, with a Mercer Harmonics Device pictured in FIG. 41, FIG. 34, FIG. 37, or FIG. 45 and the bass bar with a Mercer Bass Bar pictured in FIG. 50, FIG. 54, FIG. 58, FIG. 62, or FIG. 66, and adds a Mercer Bass Bar Acoustic Device pictured in FIGS. 70, 71, 75 and 79, or multiples of these devices as pictured in FIGS. 76 and 81. In accordance with the spirit of the invention, all the apparatus' components utilize technology that efficiently transfers and recycles previously lost sound vibrations, and use components whose wood grain direction is oriented for optimally increased sound flow. Its components are also designed with low-impedance to movement characteristics as well as flexibility and optimal sound transmission characteristics. These combined characteristics result in a two-fold increase in dominance and distance of sound projection, and increased resonance capability with only half the bowing effort.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

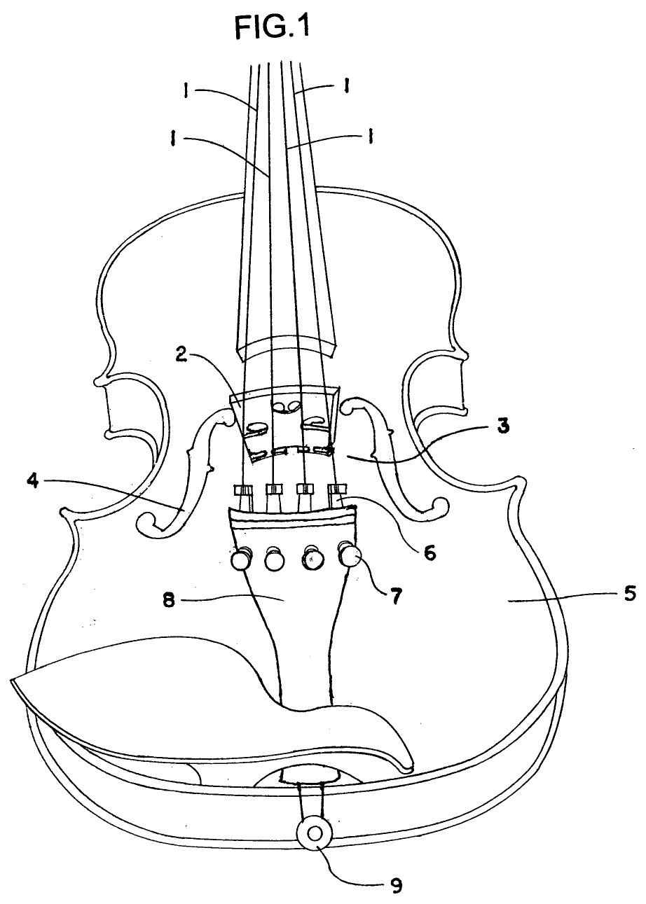

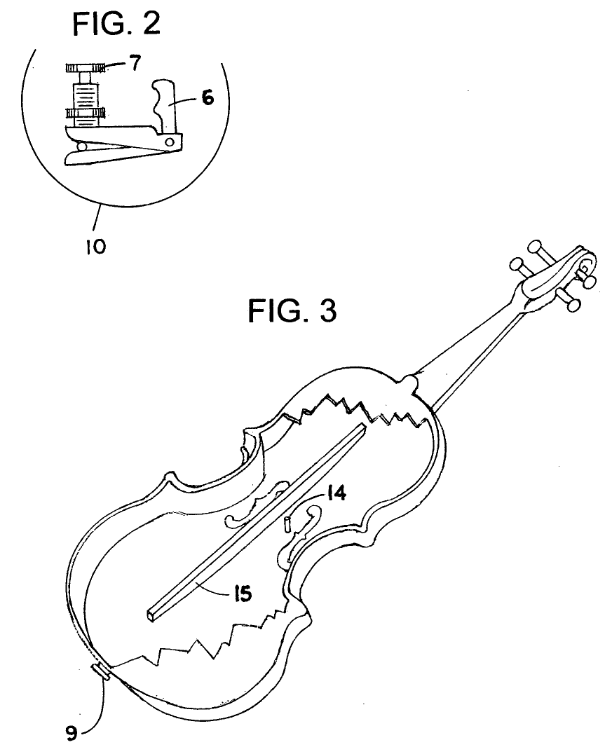

Drawings: FIG. 1, FIG. 2 and FIG. 3 refer to old technology and contain numbered traditional violin family parts.

### Acoustics Post

FIGS. 4 through 24, refer to the acoustic post styles designed with an elongated central shaft having plurality of projecting blade like wings referred to as “acoustic wings” 21 which absorb and retransmit sound vibrations that add to the violin sound. The design can be made from any sound-conducting material that can be vibrated and retransmit sound vibrations. In accordance with the important features of the present invention, there is shown in FIGS. 21 through 24, an embodiment of both vertical and horizontal wooden blades extending from the central shaft with the lower part of this design consisting of 4 blades extending outward 360 degrees with the flat side facing upward. The number and placement can be varied by using different numbers of blades as well as placing these blades at any location on the central shaft. Also, multiples of the central shaft design can radiate out from the central shaft. This embodiment forms an irregular trapezoid shape with the plurality of wooden blade acoustic wing configurations in both horizontal and vertical planes. A better balanced design should have main arm radiating wings in a balanced manner so that a 4 configuration would occur every 90 degrees or in a 5 configuration, every 72 degrees. Better balanced acoustic posts require reduced adjustments because they shift less. The spirit of this design has wooden, metal, plastic, lead crystal, or any other sound conducting material comprising the blade-like acoustic wings, 21 extending internally that absorb and retransmit internal sound vibrations that in the past have been lost. This embodiment illustrates the unlimited configurations and shapes that would absorb and retransmit sound vibrations. There are no prior inventions like this.

### Mercer Bridges

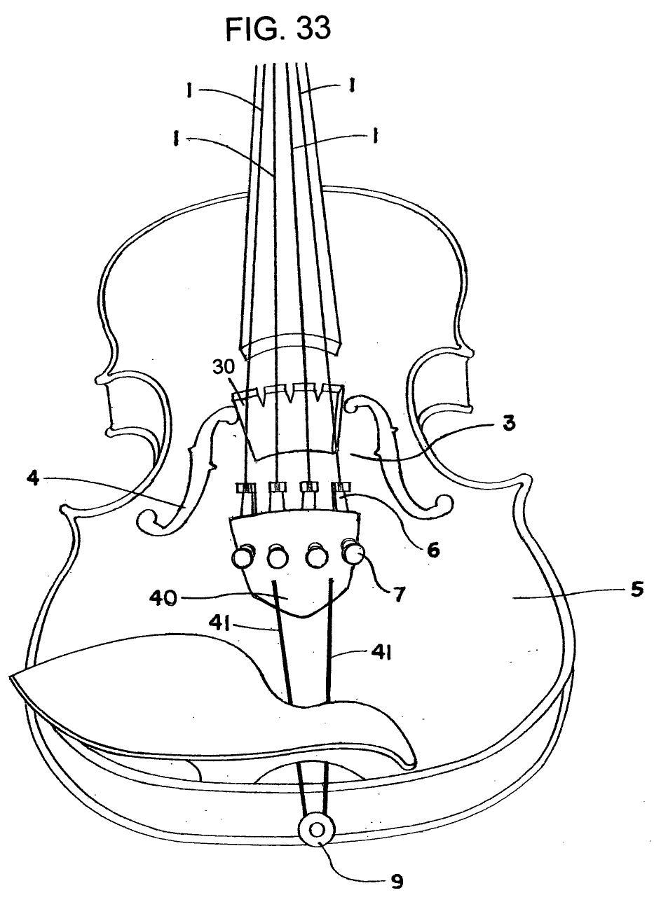

FIGS. 25 through 32 shows the Mercer Bridges. The most important change to the bridge is the entire slightly fluted contoured bottom surface design which conforms with, touches, and has full contact with the bridge placement area 3, thus increasing the surface of the sound transfer area which equates to a larger volume of sound vibrations reaching the top plate of the violin. The spirit of this part of the invention is to build the central portion of the bridge as shown with no apertures to interrupt sound vibrations and the bridge's ability to transfer sound through its entire bottom surface and have optimal sound flow characteristics by orienting the grain of the wood in a perpendicular direction to the violin strings. In one embodiment of the Mercer Tri-Notch Bridge illustrated in FIG. 29 and having a bass notch 39, a tenor notch 38, and a treble notch 37, these isolation notches measured ⅜″ deep and 3/16″ wide at the top and the bottom of the bridge measured 1¼″ wide. In this particular invention this is especially important with the bass notch 39 because the other much higher frequency output strings tend to accelerate the lower frequency G string (98 hertz) with far more intensity than a regular violin giving the G a less “bass” sound that is easily corrected with this feature. Comparatively prior Stradivarius style violin bridges had two small feet to transmit sound vibrations and decorative filigree apertures which blocked sound vibrations as they tried to pass through the bridge into the violin

### Harmonics Device or Devices

FIG. 33 is a starting reference point for the harmonics device showing a single piece or Mercer Uno Harmonics Device positioned as a tailpiece in a violin.

FIGS. 34 through 39 shows examples of a receiving member of a Mercer Uno Harmonics Device, FIGS. 40 through 43 the two separate receiving members of the Mercer Dual Harmonics Devices, and FIGS. 44 through 48 illustrates the four separate receiving members of the Mercer Quad Harmonics Devices, with FIGS. 34 through 43 designed having string adjusters 10 secured in the receptacles at one end of the receiving member, and the heavy musical string 41, secured in the receptacle at the other end and looping over the endpin 9 for attachment. The characteristics of its lightweight material, which gives it a low impedance to movement characteristic and the flexibility as well as the sound carrying characteristics of the heavy musical string, results in a two fold increase in dominance and distance of sound projection, and increased capacity to resonate, and initiates string vibrations with half the bowing effort. These acoustic improvements are further enhanced by the heavy musical string that carries sound vibrations to the endpin which is placed in the heaviest wooden framing block of the violin. This in turn recycles the vibrations back to the violin body for fuller richer tone. Comparatively, in prior art, the tailpiece is only designed for string attachment. The invention's light-weight strings adjuster platform can be made from most any sound conducting material such as metal, poly plastics, composites, or lead crystal and still function acoustically while its two-part or four-part design allows for the “away from the bridge distance” to be user-adjusted by lengthening or shortening the heavy musical string length. This adjustable “away from the bridge distance” gives the bass side more power. Also, tuning can be accomplished by replacing the pegs with a machine head illustrated in FIG. 44, or string adjusters can be left out so that the violin would be tuned only by the pegs. Alternatively, the violin strings could be tied, spliced or attached directly to the heavy musical strings themselves by way of a miniature turnbuckle or direct knot leaving out the strings receiving member all together.

### Mercer Bass Bars

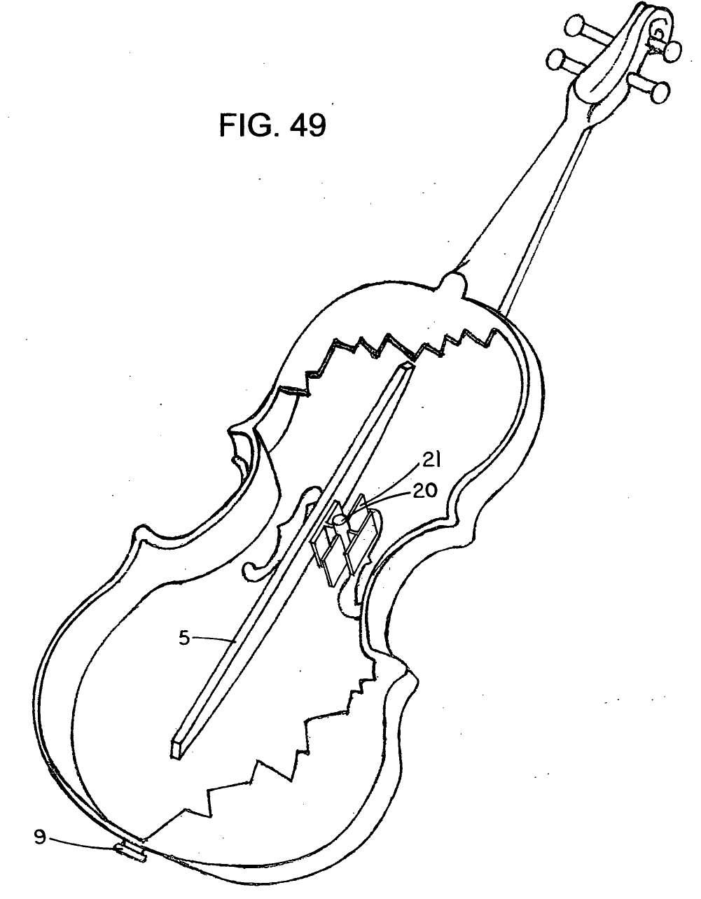

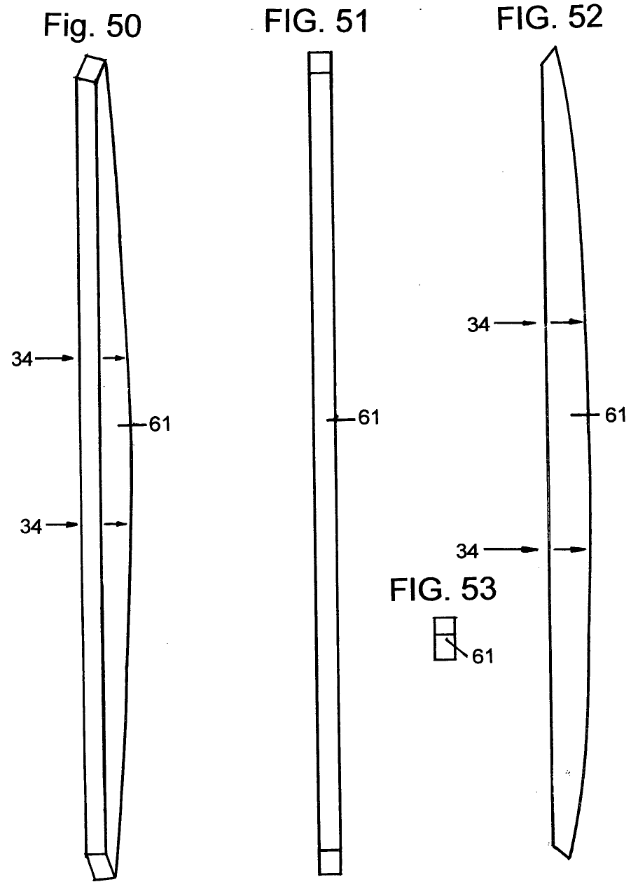

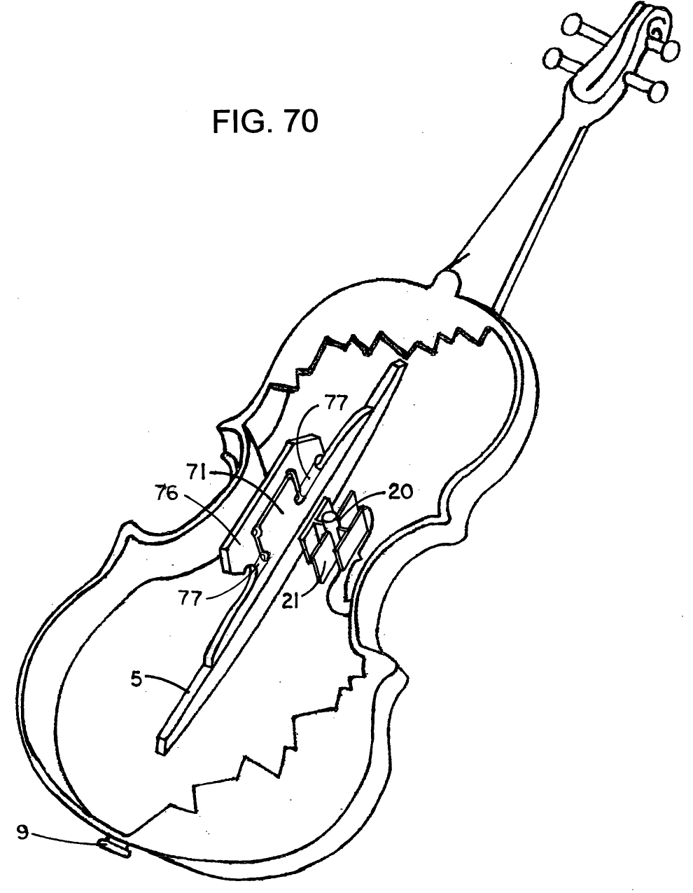

FIGS. 49 through 69 illustrate the Mercer I bass bar, Mercer II bass bar, Mercer III base bar, Mercer IV bass bar and Mercer V bass bar which are characterized with wood grain direction orientation giving it optimal sound flow characteristics 34, and a series of added arches called amphidome arches 51 gives structural support strength, but at the same time accomplishes its structural job in a less cumbersome manner allowing freedom of movement or vibration in the between the arch feet areas. This is a newly invented violin part and there are no other bass bars designed in this manner. FIGS. 50 through 53 illustrate a bass bar with a flat and straight outward surface rather than a traditional more oval shape and also with the grain direction reversed from a normal bass bar so that it is oriented perpendicular to the strings 34 giving it optimal “with the grain” sound flow characteristics and forming the Mercer I bass bar. FIGS. 54 through 57 illustrates the same bass bar design as in FIGS. 50 through 53 but differs by adding a series of amphidome arches or notches 50 to the attachment side of the bass bar converting it to a Mercer II bass bar. FIGS. 58 through 61 illustrates a Mercer style and shape bass bar with a flat and squared off outer surface which is a laminate with a 3 mm thick center portion the grain oriented perpendicular to the strings 34, and plated on the outer edges with the plating grain running in the opposite direction oriented parallel to the strings 55 and forming the Mercer III bass bar. FIGS. 62 through 65 illustrates the same bass bar design as FIGS. 58 through 61 but differs by adding a series of amphidome arches or notches 50 to the attachment side of the bass bar forming the Mercer IV bass bar. FIGS. 66 through 69 illustrates a Mercer style and shape squared off and flat bass bar with the grain oriented parallel to the strings 55, and a series of amphidome arches or notches 50 added to the attachment side of the bass bar forming a Mercer V bass bar.

### Bass Bar Acoustic Devices

FIGS. 70 through 83 illustrates various Mercer Bass Bar Acoustic Device structures that can be attached to the bass bar of a violin or illustrating that multiple Bass Bar Acoustic Devices can be installed in a single violin or illustrating that the bass bar and bass bar acoustic device can be combined together and carved from one solid piece of wood eliminating glue joints and forming The Mercer Acoustic Bar. All Mercer Bass Bar Acoustic Devices are designed with a thin 2½ mm thick vibrato area 77 for easy start-off vibration movement on the outer perimeter acoustic area 76. This helps start the vibration movement in the heavier inner acoustic rudder area 71. These acoustic areas carry internally absorbed vibrations to the bass bar and in turn to the top plate adding these enhancements to the violin sound. There is no prior art or prior inventions for a Bass Bar Acoustic Device. This concept has never been used before this invention. Wood is best construction material, but the Mercer Bass Bar Acoustic Device can be made out of any material capable of carrying sound. The spirit of the invention is to attach “acoustic devices” at any or all points of the bass bar as illustrated in FIGS. 71, 75, or 78 that absorb and retransmit internal sound vibrations to the top violin plate. This is accomplished by attachment to the bass bar which is directly attached to the inside of the top violin plate.

### One Piece Bass Bar and Bass Bar Acoustic Device Options

FIGS. 82, and 83 shows that just as a violin can have a two-piece, or preferably a one-piece back, these two parts, the bass bar and the Mercer Bass Bar Acoustic Device can be made together out of one solid piece of wood with the grain direction oriented perpendicular to the direction of the strings 34, and with the added strength of a well made part without glue joints.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

I claim:

1. A stringed instrument of the violin family, said instrument having a body including a top plate spaced from a back by enclosed sides to form a chamber there between, a neck, a bridge, playing strings played with a bow to provide musical vibrations, a sound post, a bass bar, a tailpiece, and end means, wherein improvement comprise,
a) a harmonic device comprising a member mounted in position as a tailpiece and said member including receptacles for receiving respective ones of said playing strings;
b) string adjusters on said member for respectively engaging and adjusting said strings;
c) at least one flexible wire that is relatively heavy in comparison to said playing strings;
d) the ends of said at least one relatively heavy flexible wire being affixed to said string receiving member, and
e) said at least one wire being fastened to said endpin means for carrying sound vibrations from said member to said endpin means which recycles the vibrations back into the violin body to thereby add to and amplify string vibrations,
therby enabling the violin playing strings to vibrate with reduced bowing effort while enabling an increase in dominance, in distance of sound projection and capability to resonate to thus improve and amplify the sound produced by the violin.

2. Apparatus as in claim 1 wherein said flexible wire comprises a relatively heavy guitar wire of about 56 gauge and said wire is fastened to said endpin means by looping said wire around said end pin means.

3. Apparatus as in claim 1 wherein the weight of the string receiving member of the harmonic device is of a light weight in the proximity of 1.25 ounces.

4. A violin as in claim 1 wherein said heavy musical string ends are the ends of a single musical string that is looped around said end pin means to form an attaching loop.

5. Apparatus as in claim 1 wherein said member for said harmonic device comprises a relatively light weight.

6. Apparatus as in claim 1 wherein said harmonic device comprises a plurality of members.

7. Apparatus as in claim 1 wherein said string receiving member comprises two separate pieces, each of said pieces receiving two playing strings, and end of said heavy musical string being attached to respective ones of said pieces.

8. Apparatus as in claim 1 wherein said member comprises four separate pieces one for each playing string, a relative heavy musical string having an end attached to each of said pieces, an end at first musical string being attached to respective ones of said higher frequency strings, and end of a second musical string being attached to respective ones of said lower frequency strings, and the loops formed by said musical strings being looped around said end pin means.

9. A harmonic device for a stringed instrument of the violin family wherein said instrument includes a body, strings played by a bow to vibrate and produce musical tones, a tailpiece, and end pins means, said harmonic device comprising
a) a playing string receiving member positioned as a tailpiece;
b) receptacles in said member for receiving respective ones of said playing strings;
c) string adjusters on said member for respectively engaging and adjusting said playing strings;
d) at least on relatively heavy musical string having its respective two ends affixed to said member; and,
e) said at least one relatively heavy musical string being looped around said end pin means for carrying sound vibrations from said member to the end pin means which recycles the vibrations back into the violin body to thereby add to and amplify string vibrations,
thereby enabling the violin playing strings to vibrate with reduced bowing effort while enabling an increase in dominance, in distance of sound projection and capability to resonate,

10. A stringed instrument of the violin family, said instrument having a body including a top plate spaced from a back by enclosed sides to form a chamber there between, a neck, a bridge, playing strings played with a bow to provide musical vibrations, a sound post, a bass bar, a tailpiece, and end pin means, the improvement comprising,
a) an acoustic post formed as an elongated center shaft mounted in said chamber in lieu of said sound post;
b) at least two blades comprising acoustic wings mounted on said shaft with the broad plane of said blades being parallel to the axis of said shaft and extending outwardly from said shaft; and
c) said at least two blades mounted to project in opposing directions relative to one another from said shaft axis to,
whereby said blades or acoustic wings function to absorb and retransmit sound vibrations developed in said chamber which sound vibrations may have heretofore been lost.

11. Apparatus as in claim 10 wherein said acoustic post comprises four blades symmetrically mounted on said shaft.

12. Apparatus as in claim 10 wherein said acoustic post includes a plurality of blades extending from said shaft.

13. Apparatus as in claim 10 wherein said acoustic post comprises a plurality of blades extending from said shaft, selected ones of said blades being mounted to have their broad planes parallel to the axis of said shaft, and others of said blades being mounted at an angle to the axis of said shaft.

14. Apparatus as in claim 10 wherein said acoustic post includes a plurality of blades positioned to form a balanced configuration.

15. An acoustic post for a stringed instrument of the violin family, said instrument having a body including a top plate spaced from a back by enclosed sides to form a chamber there between, a neck, a bridge, playing strings played with a bow to provide musical vibrations, a sound post, comprising
a) an acoustic post formed as an elongated center shaft for mounting in said chamber in lieu of said sound post;
b) at least two blades comprising acoustic wings mounted on said shaft with the broad plane of said blades being parallel to the axis of said shaft and extending outwardly from said shaft; and
c) said at least two blades mounted to project in opposing directions relative to one another from said shaft axis
whereby said blades or acoustic wings function to absorb and retransmit sound vibrations developed in said chamber which sound vibrations may have heretofore been lost.

16. A stringed instrument of the violin family, said instrument having a body including a top plate spaced from a back by enclosed sides to form a chamber there between, a neck, playing strings played with a bow to provide musical vibrations, a sound post, a bass bar, a tailpiece, and end pin means, the improvement comprising,
a) a bridge (a Mercer bridge) comprising a wood member with a solid mass surface and with no apertures to interrupt sound vibrations;
b) said Mercer bridge having a contoured surface for conforming to the external surface of the top plate to have substantially full contact with said surface;
c) said Mercer bridge formed to have the grain of its wood be oriented perpendicular to the direction of said strings
whereby said Mercer bridge transfer sound throughout its entire surface area in contact with said top plate.

17. Apparatus as in claim 16 wherein said Mercer Bridge is free of any filigree apertures.

18. Apparatus as in claim 16 further including
a) at least one isolation notch formed intermediate at least two string placement indents
wherein said at least one notch tends to isolate the vibration of one string from the vibration of the other strings to thereby improve the purity of the sound.

19. Apparatus as in claim 18 wherein said Mercer Bridge includes only a bass isolation notch
whereby the output of the tendency of the higher frequency strings to influence and speed up the lowest frequency string is reduced.

20. Apparatus as in claim 18 wherein said Mercer bridge includes a bass isolation notch, a tenor isolation notch and a treble isolation notch.

21. Apparatus as in claim 18 wherein said notches are symmetrical v-shaped notches approximately ⅜″ inch in depth and approximately 3/16″ in width.

22. A bridge for supporting the strings of a stringed instrument of the violin family, said instrument having a body including a top plate spaced from a back by enclosed sides to form a chamber there between, a neck, playing strings played with a bow to provide musical vibrations,
a) said bridge (a Mercer bridge) comprising a wood member with a solid mass surface and with no apertures to interrupt sound vibrations;
b) said Mercer bridge having a contoured surface for conforming to the external surface of the top plate to have substantially full contact with said surface;
c) indents for supporting said strings; and
d) said Mercer bridge formed to have the grain of its wood be oriented perpendicular to the direction of said strings
whereby said Mercer bridge transfers sound throughout its entire surface area in contact with said top plate.

23. A stringed instrument of the violin family, said instrument having a body including a top plate spaced from a back by enclosed sides to form a chamber there between, a neck, a bridge, playing strings played with a bow to provide musical vibrations, a sound post, a tailpiece, and end pin means, the improvement comprising,
a) a bass bar comprising an elongated bar of wood contoured to mount on said back of top plate within said chamber; and
b) said wood bar being formed to have the grain of the wood oriented to be perpendicular to the axis of the strings
whereby the vibrations are spread more fully along the top of the violin.

24. Apparatus as in claim 23 wherein
a) a surface of the bass bar is contoured to conform to the inner surface of said back; and
b) a series of amphidome notches formed on the surface of the bar contacting said back for providing minimal surface contact yet maintaining structural strength to said bar.

25. Apparatus as in claim 23 wherein said bass bar is formed of laminated members.

26. Apparatus as in claim 23 wherein said bass bar comprises
a) a first section having a first elongated surface for contacting said back, and a outer shoulder centered to extend outwardly from the opposed surface;
b) a second section having a first elongated contoured surface, a recess centered in said second section, said recess extending inwardly from said first contoured surface, and tabs extending outwardly from said second section, said tabs being in substantially the same plane as said section;
c) spacing gaps formed at the ends of said recess;
d) said outer shoulder positioned in said recess with a spacing formed between said shoulder, and said recess and gaps to span said two sections; whereby the area spanning said first and second sections provides a vibrating area for easy start of vibration movement and to maximize the absorption of vibrations.

27. Apparatus as in claim 23 wherein the bass bar is made of laminated material.

28. A bass bar for a stringed instrument of the violin family, said instrument having a body including a top plate spaced from a back by enclosed sides to form a chamber there between, a neck, a bridge, playing strings played with a bow to provide musical vibrations,
a) said bass bar comprising an elongated bar of wood contoured to mount on said back and within said chamber; and
b) said wood bar being formed to have the grain of the wood oriented to be perpendicular to the axis of the strings
whereby the vibrations are spread more fully along the top of the violin.

29. A stringed instrument of the violin family, said instrument having a body including a top plate spaced from a back by enclosed sides to form a chamber there between, a neck, a bridge, playing strings played with a bow to provide musical vibrations, a sound post, a bass bar, a tailpiece, and end pin means, the improvement comprising,
a) a harmonic device comprising a playing string receiving member comprising two separate pieces positioned as a tailpiece;
b) receptacles in said member pieces for receiving said playing strings, each of said pieces receiving two playing strings;
c) a relatively heavy musical string having its ends affixed to respective ones of said pieces;
d) string adjusters on said member pieces for respectively engaging and adjusting said playing strings;
e) said musical string being looped around said end pin means for carrying sound vibrations from said member pieces to said end pin means to thereby recycle the vibrations back to the violin body to thereby add to and amplify string vibrations;
f) an acoustic post formed as an elongated center shaft mounted in said chamber substituted for said sound post;
g) said acoustic post having a least two blades comprising acoustic wings mounted on a shaft with the broad plane of said blades being parallel to the axis of said shaft and extending outwardly from said shaft;
h) said at least two blades mounted to project in opposing directions relative to one another from said shaft axis and said blades or acoustic wings function to absorb and retransmit sound vibrations developed in said chamber which sound vibrations may have heretofore been lost;
i) a bridge (a Mercer bridge) comprising a wood member with a solid mass surface and with no apertures to interrupt sound vibrations;
j) said Mercer bridge having a contoured surface for conforming to the external surface of the top plate to have substantially full contact with said surface;
k) said Mercer bridge formed to have the grain of its wood be oriented perpendicular to the direction of said strings;
m) a bass isolation notch formed in said Mercer bridge to reduce the tendency of the higher frequency strings to influence and speed up the lowest frequency string; and
n) a bass bar contoured to conform to the inner surface of said back enabling said bass bar to transfer sound throughout its entire surface area to said top plate
o) apparatus part as in claim 29 with bass bar acoustic device comprising of an outer perimeter acoustic area and having a vibrato area of very thin material whereby providing an area for easy start of vibration movement;
p) starting vibrations in the acoustic rudder which is caused to vibrate by said outer perimeter area to then couple these vibrations to the upper violin top plate which thereby causing the vibrations to go to the outer area then to the acoustic rudder and then to the upper violin plate thereby enhancing the sound vibrations

30. A stringed instrument as in claim 1 wherein the bass bar and an outer perimeter acoustic area extending from the bass bar are provided with a thin vibrato area and acoustic rudder area that are formed from a single piece of wood.
whereby said violin playing strings vibrate with reduced bowing effort while enabling an increase in dominance, in distance of sound projection and capability to resonate to thus improve the sound produced by the violin
